(19) United States
(12) Patent Application Publication
(10) Pub. No.: US 2016/0127448 A1
(43) Pub. Date: May 5, 2016

(54) WEARABLE DEVICE INCLUDING MODULAR FUNCTIONAL BLOCK AND METHOD FOR EXTENDING FUNCTION OF WEARABLE DEVICE USING MODULAR FUNCTIONAL BLOCK

(71) Applicant: Korea Electronics Technology Institute, Seongnam-si (KR)

(72) Inventors: Jong Bin PARK, Hwaseong-si (KR); Tae Beom LIM, Seongnam-si (KR); Kyung Won KIM, Seoul (KR); Jong Jin JUNG, Seoul (KR); Seung Woo KUM, Yongin-si (KR); Jae Won MOON, Seoul (KR)

(73) Assignee: Korea Electronics Technology Institute, Seongnam-si (KR)

(21) Appl. No.: 14/620,802

(22) Filed: Feb. 12, 2015

(30) Foreign Application Priority Data
Nov. 5, 2014 (KR) 10-2014-0152928

(51) Int. Cl. H04L 29/08; G06F 9/54; G06F 13/38

(52) U.S. Cl. CPC H04L 67/06; G06F 13/38; G06F 9/54

(57) ABSTRACT

Disclosed are a wearable device including a modular functional block and a method for extending a function of a wearable device using a modular functional block. The wearable device including the modular functional block according to an embodiment of the present invention includes a plurality of functional blocks that are removably fastened to a strap connected to a main block of the wearable device. Here, a processing block of at least one of the main block and the plurality of functional blocks recognizes a mounting state of each of the other functional blocks, and generates application information provided in a combination of the functional blocks fastened to the strap.

### CROSS-REFERENCE TO RELATED APPLICATION

This application claims priority to and the benefit of Korean Patent Application No. 10-2014-0152928, filed on Nov. 5, 2014, the disclosure of which is incorporated herein by reference in its entirety.

### BACKGROUND

1. Field of the Invention

The present invention relates to a wearable device including a modular functional block and a method for extending a function of a wearable device using a modular functional block.

2. Discussion of Related Art

As the smartphone market reaches maturity, a wearable device has been proposed as mobile technology that substitutes the smartphone in the future.

The wearable device may be classified into an accessory type wearable device, a textile/clothing type wearable device, a body-mounted type wearable device, and a body implantable type wearable device, and linked with smart devices to perform an auxiliary role.

A watch, that is an example of a typical wearable device, may be equipped with various additional functions in addition to the original function to tell time, and thus effectiveness of the watch has been increasing.

That is, in recent years, there has been proposed the watches that can collect a variety of pieces of external environmental information by integrating a geomagnetic sensor, a global positioning system (GPS) receiver, and atmospheric pressure and temperature sensors as well as simple additional functions such as timer and alarm functions or the like, and support health care services by acquiring biological signals such as blood pressure or pulse.

In addition, such watches may be equipped with an additional communication function so as to be linked with external devices or systems, and therefore the evolution to wearable network devices is accelerating.

However, conventionally, as to these additional functions of the watch, the specification and function of the watch are determined for each model in consideration of manufacturing costs and the technology integration level at the time of manufacturing, and then the watch is provided to users in the form of a finished product.

Thus, the user cannot arbitrarily change the hardware configuration of the product that has been already purchased.

As an example, when the user purchases a clock that does not include a blood pressure measurement sensor, the corresponding function (blood pressure measurement function) cannot be used even in the future through the purchased clock.

Conversely, when a specific sensor is unnecessary, the user additionally pays for the unnecessary sensor with respect to the product including the unnecessary sensor. Thus, this may be an unnecessary waste as viewed from the user's point of view.

Similarly, even conventional smart devices capable of extending the functions of the watch have these problems.

The watch and watch strap-related technologies according to the related art have presented a configuration of adding a variety of functions to the watch, technology of firmly and flexibly configuring physical coupling of the watch strap, a configuration of adding special functions such as antennas, a configuration of providing communication functions such as a USB, and the like, but still imply the above-described problems.

### SUMMARY OF THE INVENTION

The present invention is directed to a wearable device including a modular functional block which may provide new functions and services through a combination of functional blocks in accordance with a mounting state of a removable functional block that provides a unique function based on a strap of the wearable device represented by a potable clock, and a method for extending a function of a wearable device using the modular functional block.

According to an aspect of the present invention, there is provided a wearable device having a modular functional block including: a plurality of functional blocks that are removably fastened to a strap connected to a main block of the wearable device, wherein a processing block of at least one of the main block and the plurality of functional blocks recognizes a mounting state of each of the other functional blocks, and generates application information provided in a combination of the functional blocks fastened to the strap.

According to another aspect of the present invention, there is provided a method for extending a function of a wearable device using a modular functional block, including: (a) detecting at least one of an event in which a functional block is mounted to a strap of the wearable device and an event in which the functional block is removed from the strap thereof; (b) recognizing a mounting state of the functional block in accordance with the event in which the functional block is mounted to the strap or the event in which the functional block is removed from the strap; and (c) generating application information provided in a combination of the mounted functional blocks.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a conceptual diagram illustrating a main block, a strap, and a mounting/removing region of a wearable device according to an embodiment of the present invention;

FIG. 2 is a conceptual diagram illustrating a wearable device including a modular functional block according to an embodiment of the present invention;

FIG. 3 is a diagram illustrating a coupling relationship of functional blocks according to an embodiment of the present invention;

FIG. 4 is a diagram illustrating a kind of a functional block according to an embodiment of the present invention;

FIG. 5 is a diagram illustrating a logical configuration between functional blocks and a control method according to an embodiment of the present invention; and

FIG. 6 is a flowchart illustrating a method for extending a function of a wearable device using a modular functional block according to an embodiment of the present invention.

### DETAILED DESCRIPTION OF EXEMPLARY EMBODIMENTS

Example embodiments of the present invention are disclosed herein. Also, specific structural and functional details disclosed herein are merely representative for purposes of describing the example embodiments of the present invention. However, the example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Hereinafter, preferred embodiments of the present invention will be described in detail with reference to the accompanying drawings. To aid the understanding of those skilled in the art in detailed descriptions of the present invention, a watch that is typically used as a wearable device will be described.

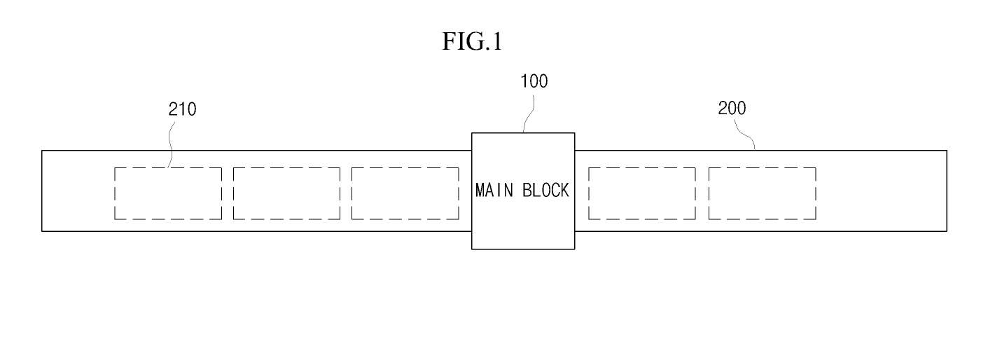

FIG. 1 is a conceptual diagram illustrating a main block, a strap, and a mounting/removing region of a wearable device according to an embodiment of the present invention.

As illustrated in FIG. 1, the wearable device according to an embodiment of the present invention has a similar configuration to that of a typical watch, and includes a main block 100 corresponding to a body of the clock and a strap 200 for coupling the wearable device to a wrist or the like. The main block of the typical watch includes a power supply unit, a periodic signal generating unit, a processing unit, and a screen display unit, and the like in order to achieve the object for displaying the time. In addition, the strap may be manufactured using cloth, leather, a metal chain, or the like in accordance with its design and application, and serve to securely attach the watch to a human body.

In order to solve the problem that cannot be overcome in the related art, the strap 200 according to an embodiment of the present invention includes a mounting/removing region 210 in which the functional block can be mounted or removed and a circuit that supports power supply and communication, so that a variety of additional functions on the strap of the wearable device may be selectively provided out of the above-described limited functions.

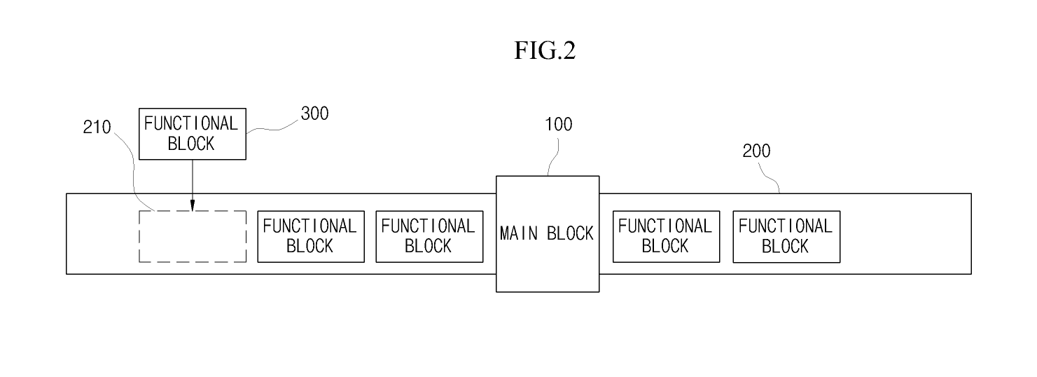

FIG. 2 is a conceptual diagram illustrating a wearable device including a modular functional block according to an embodiment of the present invention.

As illustrated in FIG. 2, the wearable device according to an embodiment of the present invention includes a plurality of functional blocks 300 that are removably fastened to the strap 200 connected to the main block 100, and a processing block of at least one of the main block 100 and the plurality of functional blocks 300 recognizes a mounting state of each of the other functional blocks, and generates application information provided in a combination of the functional blocks 300 fastened to the strap 200.

That is, according to an embodiment of the present invention, new functions and services may be provided in accordance with a combination of the functional blocks 300 mounted to the mounting/removing region 210 disposed on the strap 200.

In the embodiments described with reference to FIGS. 1 and 2, a configuration in which the mounting/removing region 210 is present in the strap 200 has been described, but the functional blocks 300 may also act as the strap using a method in which the functional blocks 300 and the wearable device are fastened together using magnets, hooks, wires, straps, claspers, or the like. This may be changeable in accordance with the size of the functional blocks 300 and the design of the strap 200 and the wearable device itself, and the scope of the present invention is not limited in accordance with a physical coupling method for the functional blocks.

When being operated in conjunction with the functional blocks 300, the main block 100 illustrated in FIGS. 1 and 2 may be utilized as an integrated central processing device and a main power supply source. In addition, in this case, the main block 100 may display information collected from the functional blocks 300 on a screen display unit of the main block 100. The main block 100 includes some or all of functions which the functional blocks 300 have, controls the functional blocks 300, and acquires state information of the functional blocks 300.

However, a watch as the typical wearable device is considered as a work of art, and therefore the aesthetic design and specifications for the main block 100 are important considerations. Thus, in the present invention, in consideration of characteristics of such a watch, the main block 100 may be implemented even without being necessarily interacted with the functional blocks 300 mounted on the strap 200. That is, the main block 100 may be replaced with the existing clock body.

Hereinafter, to aid the understanding of those skilled in the art, a case in which any one block of the plurality of functional blocks 300 recognizes a mounting state of each of the other functional blocks and generates application information provided in a combination of the functional blocks 300 fastened to the strap 200 will be described in detail.

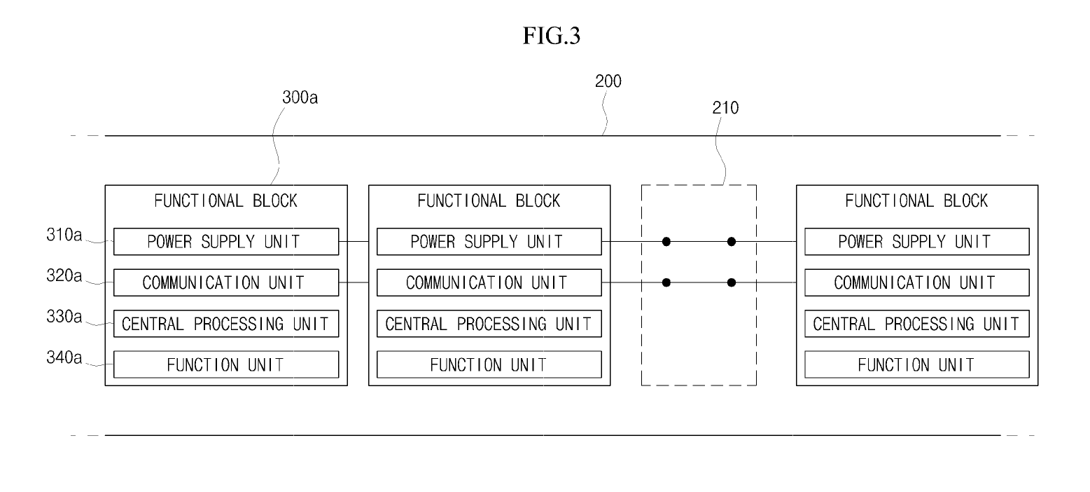

FIG. 3 is a diagram illustrating a coupling relationship of functional blocks according to an embodiment of the present invention.

The strap 200 according to an embodiment of the present invention includes a plurality of mounting/removing regions 210 in which the functional blocks 300 can be removably mounted as described above, and the multiple mounting/removing regions 210 include circuits which are mutually connected in a wired manner so that power supply and communication may be performed.

As another example, the functional blocks 300 may be operated while each having an independent power source such as a solar cell or the like, and transmit and receive information in a wireless communication manner. In this case, a wired circuit is unnecessary, but it is preferable that a coupling relationship according to an embodiment of the present invention be achieved in a wired manner in terms of reliable communication and power sharing.

In FIG. 3, physical components which are commonly included in the functional blocks according to an embodiment of the present invention are illustrated, and a functional block 300a physically includes a power supply unit 310a, a communication unit 320a, a central processing unit 330a, and a function unit 340a.

In the wired manner, the functional blocks 300 receive power supply from the adjacent main block or the power supply blocks through a power supply line connected to the circuit, or receive power supply from the power supply source of the functional block itself.

The communication unit 320a performs mutual information communication between the main block and other functional blocks of the wearable device, and may configure communication topology in the form of a tree or a typical graph. According to an embodiment of the present invention, it is preferable that a wired communication method be used for the purpose of reliable communication as described above, but according to another embodiment of the present invention, a near field wireless communication method requiring low power may be applicable.

The central processing unit 330a manages a power supply and a communication module so that the functional blocks may be operated. In addition, the central processing unit 330a processes environmental information collected through the function unit 340a and state information stored in an internal storage device, and transmits the processed information to the main block or the other functional blocks through the communication unit 320a. In addition, the central processing unit 330a includes a function processing unit that performs control and state commands received from the other functional blocks.

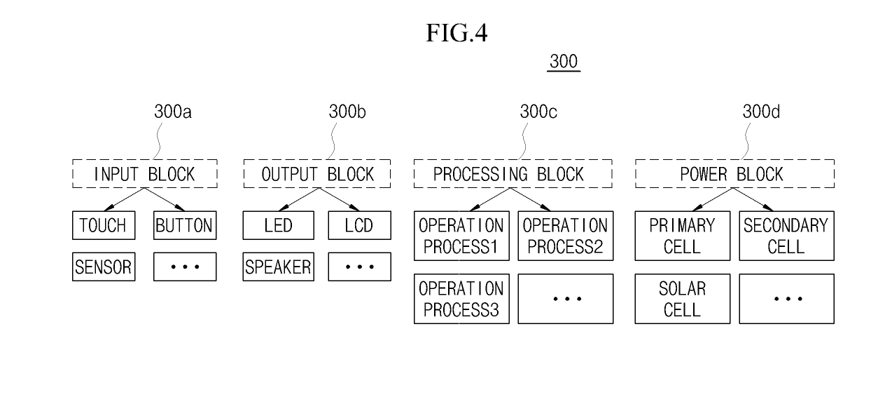

FIG. 4 is a diagram illustrating a kind of a functional block according to an embodiment of the present invention. As described above, the functional blocks 300 according to the embodiments of the present invention are mounted to the mounting/removing region of the strap and provide services to users through a combination of the functions.

Such functional blocks are classified into various types as shown in FIG. 4. As an example, the functional blocks are classified into an input block 300a, an output block 300b, a processing block 300c, and a power supply block 300d.

As examples of the input block 300a, a touch sensor, buttons, a GPS receiver, a temperature sensor, a humidity sensor, an atmospheric pressure sensor, a light quantity sensor, a gas sensor, an infrared sensor, a video image sensor, a human heart rate sensor, a body temperature sensor, and the like may be given.

As examples of the output block 300b, an optical output device such as an LED, an LED array, a 7 segment, an LCD, a screen display device such as a micro-projection display, a speaker device for outputting sounds, a laser pointer optical output device, and the like may be given.

The processing block 300c includes an arithmetic processing device that is specified in a specific function or a general purpose arithmetic processing device that is equipped with a new algorithm to execute the new algorithm.

The power supply block 300d includes a primary cell type that is used as a one-off, a rechargeable secondary cell type, a type of collecting power according to the principle of electromagnetic conduction by receiving electromagnetic waves from a remote location, a type of autonomously generating power such as sunlight or a piezoelectric element, and the like.

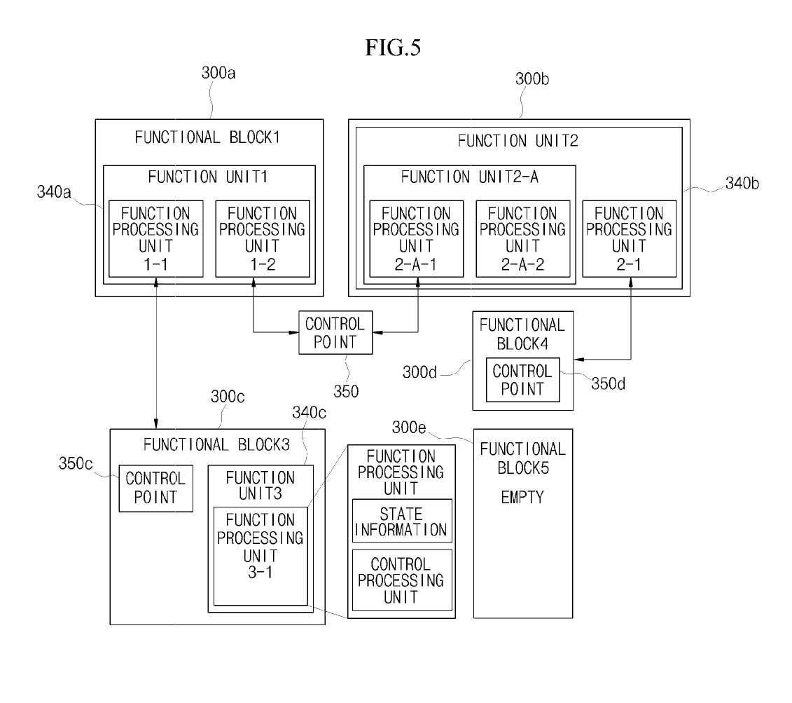

FIG. 5 is a diagram illustrating a logical configuration between functional blocks and a control method according to an embodiment of the present invention.

The total number of functional blocks illustrated in FIG. 5 is 5, and a single control point 350 that is exposed to the outside is included. The functional blocks may not or may include at least one function unit, and the function unit is a constituent component that defines and processes explicit functions provided by the functional blocks.

For example, the functional block that measures the ambient temperature includes a temperature collection function unit as an internal module. At least one function processing unit is included in the function unit, and according to an embodiment of the present invention, the function processing unit may be considered as a minimum unit of performing functions.

As an example of the temperature collection function unit included in the functional block that measures the temperature, a plurality of function processing units such as acquiring a current temperature, acquiring an average temperature for the last one hour, correcting values of a thermometer, and the like may be included in the upper-level function unit.

A functional block 1 (300a) illustrated in FIG. 5 includes a single function unit 340a, and the function unit 1 (340a) includes two function processing units.

As another example, each of the functional blocks may include at least one function unit, and the number of function units included in the corresponding functional block may be changeable according to the design. For example, in a case in which the same function may be performed by enabling a plurality of function processing units to be included in the single functional block even though the functional block includes a single function unit rather than enabling a plurality of function units to be included in the single functional block, the functional blocks may be constituted in this manner.

A functional block 2 (300b) illustrated in FIG. 5 includes a lower-level function unit within the function unit 340b. This implementation method may be recursively performed, but the complexity according to an inclusion relationship may be increased, and therefore restrictions may be necessary at the time of actual implementation.

As in a control point 350c included in a functional block 3 (300c), a control point may be included in the functional block. The control point actually controls the function processing unit to acquire a state value from the function processing unit, or changes the state value of the function processing unit to actually perform the corresponding function.

As an example, such a control point may be included in the functional block to control the other functional blocks, and as another example, the control point may be present in the outside of the functional block to thereby control the function processing unit and to thereby also support other devices to control the functional blocks according to a physical level-communication protocol.

As shown in an enlarged diagram of a function processing unit 3-1 of FIG. 5, the function processing unit may include state information and a control processing unit. The control processing unit may perform actual control or return the corresponding result using interaction with the control point and internal state information.

A functional block 4 (300d) is a functional block only including a control point 350d and does not interact with other functional blocks in the same manner as in a functional block 5 (300e), but is mounted on the strap for the purpose of aesthetic design or physical fastening.

The functional block 5 (300e) may not include the power supply unit, the central processing unit, and the function unit at all or may include some thereof. In addition, the functional block 5 (300e) itself may be separately operated, and provide a unique function without interacting with other functional blocks.

In the wearable device including the modular functional block according to an embodiment of the present invention, the functional blocks 300 may be selectively mounted in the mounting/removing region 210 on the strap 200, and application information may be provided to users through a combination of the mounted functional blocks 300.

In this instance, the wearable device including the modular functional block according to an embodiment of the present invention may provide the users with application information currently provided when the functional blocks 300 are mounted. In addition, as another example, the wearable device including the modular functional block according to an embodiment of the present invention may transmit a kind of the mounted functional block 300 to a server, download application information that is newly developed according to the combination of the functional blocks presented on an app market, and display the downloaded application information to users.

That is, according to an embodiment of the present invention, available services combined through a unique function of each of the functional blocks 300 may be provided to users, and with respect to services which are not currently provided, discovery of new services may be attempted through the combination of the functional blocks 300. In addition, a user may display services which can be provided when additional functional blocks other than the currently mounted functional block 300 are mounted, and therefore additional effects of inducing mounting of the additional functional blocks may be expected.

The wearable device including the modular functional block according to an embodiment of the present invention may provide services according to the combination of the selectively mounted functional blocks 300 to users, and may further include a rotating bezel formed on an outer surface of the main block on the strap 200 in order to improve user intuitiveness. In this instance, when the user rotates the rotating bezel, the mounted functional blocks 300 may be selectively activated according to the application information provided in the combination of the functional blocks 300. The above-described rotating bezel is a means for selectively activating each functional block according to the application which a user wishes to intuitively execute, and a button input method, a voice recognition method, a motion recognition method, and the like may be also applicable.

As an example of the wearable device including the modular functional block according to an embodiment of the present invention, a location-based motion information logging system will be described.

According to this example, a watch that is the wearable device includes a functional block for supplying power, a functional block for receiving GPS information, a functional block for sensing a heart rate, a functional block for displaying a screen, a functional block for storing the functional block, and a functional block for detecting vibration.

The functional block for displaying the screen includes a control point, and the control point may receive heart rate information from the functional block for sensing the heart rate, location information from the functional block for receiving the GPS information, motion information per second from the functional block for detecting vibration, and remaining power from the functional block for supplying power, and display the received information.

In addition, the functional block for displaying the screen which acts as the above-described processing block logs location-based motion information, and transmits and stores a record as the functional block for storing the record.

The functional blocks according to the embodiments of the present invention may be mounted to or removed from the mounting/removing region of the strap, and when the functional block for sensing the heart rate and the functional block for receiving the GPS information are removed, the processing block may recognize this mounting state and re-constitute the location-based motion information logging system to provide the corresponding services to users.

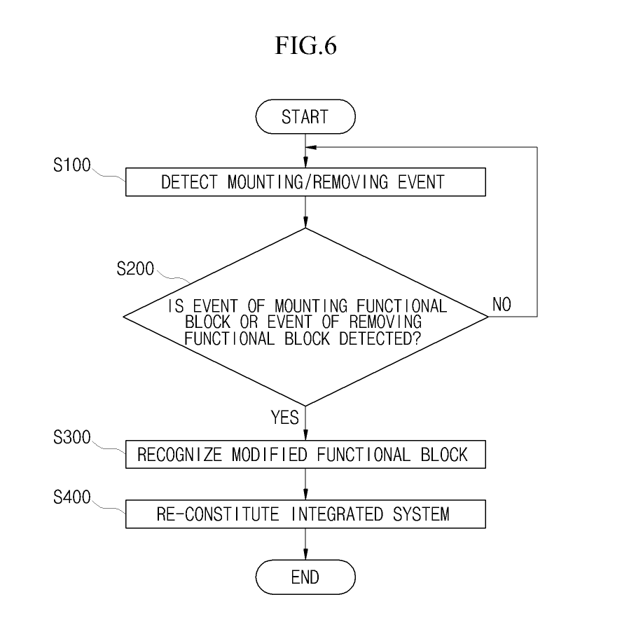

FIG. 6 is a flowchart illustrating a method for extending a function of a wearable device using a modular functional block according to an embodiment of the present invention.

The method for extending the function of the wearable device using the modular functional block according to an embodiment of the present invention includes operation S100 of detecting at least one of an event in which a functional block is mounted to a strap of the wearable device and an event in which the functional block is removed from the strap thereof, operation S300 of recognizing a mounting state of the functional block in accordance with the event in which the functional block is mounted to the strap or the event in which the functional block is removed from the strap, and operation S400 of generating application information provided in a combination of the mounted functional blocks.

When power is applied to each of the functional blocks, the functional block may propagate functional characteristics which the respective functional blocks have, using a predetermined interface protocol. In this instance, when requesting propagation of the functional characteristics, the functional blocks to which power has been already applied may also propagate the related information.

The method for extending the function of the wearable device using the modular functional block according to an embodiment of the present invention detects whether at least one of the event in which the functional block is mounted to the strap and the event in which the functional block is removed from the strap is generated in operation S100, determines whether the mounting and removal of the functional block is detected in operation S200, recognizes the functional block which is in the changed mounting state when the event is detected in operation S300, and re-constitute the functions of the wearable device based on conventional information of the mounted functional blocks to re-constitute an integrated system in operation S400.

On the other hand, when the mounting and removal of the functional block is not detected in operation S200, operation S400 of re-constituting the functions of the wearable device is not performed.

In operation S400, the integrated system of the functional blocks may be re-constituted, and specific functional blocks required for configuration of the corresponding services may perform this role to thereby provide a user customizable system.

In this instance, the functional blocks may follow a predetermined interface protocol in order to mutually provide each function thereof. As an example, the functional blocks may be configured using XML, JSON, text string, or a descriptor using a binary format as the interface protocol, and may also follow other interface protocols.

It is preferable that, by re-constituting the integrated system in operation S400, specific services be implemented by the processing block or the functional blocks including the control point, but the present invention is not limited thereto.

Operation S100 is an operation of implementing services and consuming power, and whether the event is generated may be periodically detected according to a predetermined cycle. As another example, by implementing a service routine for asynchronous signals in a hardware and software interrupt handling method, the power consumption may be reduced, or the complexity of implementation according to interlocking between the functional blocks may be reduced.

In operation S400 of re-constituting the integrated system, application information provided in a combination of the mounted functional blocks is generated, and then the generated application information is displayed to the user in the following step.

In this instance, in operation S400, the application information may be generated through the combination of the functions which the mounted functional blocks have, information about the mounting state may be transmitted to a server, and the application information provided in the combination of the functional blocks may be downloaded.

In addition, after operation S400, it is preferable that the method for extending the function of the wearable device using the modular functional block according to an embodiment of the present invention further include selectively activating the functional blocks required for providing the corresponding application in accordance with user input signals and application information.

As an example, when the operation state of the rotating bezel is changed as the user input signals, the functional blocks may be selectively activated according to the operation state of the rotating bezel and the application information, so that a user may intuitively discern the functional block required for executing the corresponding application.

As described above, according to the embodiments of the present invention, by adding or removing various functional blocks on the strap of the wearable device, the function of the wearable device may be extended or changed to a user customizable wearable device.

In addition, it is possible to control specific functions of the mounted functional blocks in conjunction with external devices of the wearable device, or acquire the state information of the functional blocks.

In addition, applications capable of being provided through the combination of the currently mounted functional blocks may be presented to users, and new applications generated through the combination of the functional blocks may be additionally downloaded to provide a user customizable function, thereby increasing user's convenience.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A wearable device including a modular functional block comprising:
a plurality of functional blocks that are removably fastened to a strap connected to a main block of the wearable device,
wherein a processing block of at least one of the main block and the plurality of functional blocks recognizes a mounting state of each of the other functional blocks, and generates application information provided in a combination of the functional blocks fastened to the strap.

2. The wearable device of claim 1, wherein the processing block transmits information about the mounting state of the functional block to a server, and downloads and displays the application information provided in the combination of the functional blocks from the server.

3. The wearable device of claim 1, further comprising:
a rotating bezel disposed on the strap,
wherein the fastened functional blocks are selectively activated in accordance with rotation of the rotating bezel and the application information provided in the combination of the fastened functional blocks.

4. A method for extending a function of a wearable device using a modular functional block, comprising:
(a) detecting at least one of an event in which a functional block is mounted to a strap of the wearable device and an event in which the functional block is removed from the strap thereof;
(b) recognizing a mounting state of the functional block in accordance with the event in which the functional block is mounted to the strap or the event in which the functional block is removed from the strap; and
(c) generating application information provided in a combination of the mounted functional blocks.

5. The method for extending the function of the wearable device of claim 4, wherein the (c) generating of the application information includes transmitting information about the recognized mounting state of the functional block and downloading the application information provided in the combination of the functional blocks.

6. The method for extending the function of the wearable device of claim 4, further comprising, after the (c) generating of the application information:
selectively activating the functional block in accordance with an operation state of a rotating bezel and the application information.
